(19) United States
(12) Patent Application Publication
(10) Pub. No.: US 2010/0039510 A1
(43) Pub. Date: Feb. 18, 2010

(54) Method and DEVICE for PRINT INSPECTION

(75) Inventors: BENNETT IRA GOLD, WORCESTER, MA (US); CHRISTOFER RICHARD BOTOS, ARLINGTON, MA (US); CRAIG THADDEOUS GRIFFIN, GROTON, MA (US)

Correspondence Address: ROBERT A. WALSH, 8100 E. CAMELBACK ROAD, # 29, SCOTTSDALE, AZ, 85251, US

(73) Assignee: APOLLO SYSTEMS, LLC, Boxborough, MA (US)

(21) Appl. No.: 12/190,871

(22) Filed: Aug. 13, 2008

(51) Int. Cl. H04N 7/18

(52) U.S. Cl. 348/92

(57) ABSTRACT

An apparatus to conduct an inspection of printed impressions placed on a conveyor transport system which is synchronized with an optical collection device that captures and digitizes the image of the impressions. The images are then reformatted and analyzed for defects using a reference image. The images are also filtered and converted to an LCH representation which further inspected using the CIE methodology. The final results of the inspection are presented to the operator in real time on a display monitor.

### BACKGROUND OF THE INVENTION

1. Field of the Invention

The invention relates, in general, to a device and method to detect print and substrate defects during a commercial printing operation.

It is particularly directed to using an optical detection system for detection and removal of color and substrate defects in color media and images during the printing process.

2. Description of the Background

Problems throughout the commercial printing industry is to identify and remove all defective printed material during the printing process to maintain the quality standard required for the final printed product by the customer The customer's standards vary over a wide spectrum of products from the highest quality, such as, for securities and bank notes to the lowest quality, such as, newsprint and stationery products. The printers strive to meet the customers requirements while keeping production costs down. In order to achieve this end, in the past printers would randomly sample their production product and check the printed impressions for color variations and other printing defects. Printers have further adapted this process by printing test patterns in the margins of the printed impressions in order to measure and ensure the accuracy of the density of the ink on each printed impression. The quality monitoring process is normally accomplished through either manual or semi-automated techniques.

The major problem is to provide a fully automated system and apparatus that is capable of detecting printing and substrate defects and measuring ink density off the entire surface of every printed impression on the surface of the media or substrate.

### SUMMARY OF THE INVENTION

In order to overcome the above mentioned problem, it is necessary to address several functional and performance issues, such as:

The requirement for gathering color information in the captured image that allows for the recognition of similarly reflective inks printed at the wrong location within the printed impression;

The presence of high contrasting areas within the captured image that cause accurate detection of defects to be unlikely;

The ability to measure the photometric ink density from a captured image of the printed impression;

The requirement to measure the captured image of an entire printed impression in a time restricted environment;

The requirement to provide the relevant information to a user in a clear and concise manner without impacting the system operation; and

The ability to synchronize with the conveyor line in order to correctly identify the defective impressions so they can be separated.

The functional and performance issues listed above have been resolved by the present invention and additional advantages are provided through a novel inspection system, incorporating a novel device and method, that provides fully-automated system capable of acquiring impression images in real-time, inspecting each image for defects and reporting the results to the operator and the impression conveyor transport so that those defects can be properly culled from the production process.

The present invention has the objective to provide a fully-automated method and apparatus that are capable of detecting printing and substrate defects and measuring ink density from high-resolution digital color images captured off the entire surface of every printed impression conveyed on an automated transport system.

The inspection system incorporates an imaging system which includes a digital line scan low noise color camera having high quality optics set that maintains horizontal pixel size and uniformity to create an image of the printed material. The camera is housed in an enclosure and mounted above a transport conveyor. The imaging system also includes an integrated illumination source. An impression sensor is used to indicate when the camera should begin to capture each image frame. A rotary encoder is synchronized with the transport motion and controls the vertical image resolution. The encoder provides pulses to the camera that controls the line readout rate and exposure time to ensure each pixel is of uniform height. The systems digitize the video image data and transmit the digital pixel data to the CPUs. This maintains high data integrity in the electrically noisy environment.

Once each impression is imaged and aligned to a golden reference image, the image is analyzed for defects using the reference image as the quality standard. The inspection system uses the CIE standard measurement of delta E (ΔE) to measure the difference from standard. The CIE defines 1ΔE as the smallest color change perceived by any one person. For each pixel in the image, the deviation from the quality standard is compared to its sensitivity detection threshold. Based on this result, defects are separated into categories of acceptable, minor, moderate and severe. These defects are then analyzed to determine their spatial characteristics and identify the actual size of the defect cluster. Once this information is found, the defect size and severity is compared to a rejection threshold to determine if the impression is acceptable or should be rejected.

Once the inspection is complete the inspected image is displayed on the flaw monitor and a results signal is set to indicate the final disposition of the inspected impression. If the impression is rejected, the defects that exceed the reject thresholds are highlighted by a red box in the flaw display image.

Additional features and advantages are realized through the techniques of the present invention. Other embodiments and aspects of the invention are described in detail herein and are considered a part of the claimed invention. For a better understanding of the invention with advantages and features, refer to the description and to the drawings.

The present invention has achieved a solution which leads to a highly accurate print and substrate defect detection and simultaneous ink density measurement on 100% of every impression imaged at production speeds. The present invention provides greater inspection performance of each impression in real-time allowing the inspection to be completed while the transport conveyor is running and generation of signals for removing defect material from the conveyor at normal production speeds.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates the operation of the present invention;

FIG. 2 illustrates a print quality management system in accordance with the present invention;

FIG. 3 illustrates the control elements of the print quality management system in accordance with present invention; and

FIG. 4 illustrates an example of the signals and relative timing during the inspection process in accordance with the present invention.

The detailed description explains the preferred embodiments of the invention, together with advantages and features, by way of example with reference to the drawings.

### DETAILED DESCRIPTION OF THE INVENTION

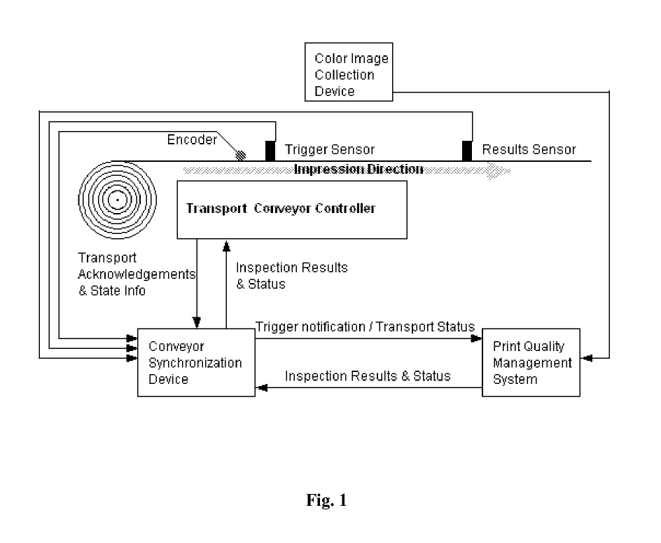

Turning now to the drawings in greater detail, FIG. 1 illustrates an embodiment of the print inspection station system components integrated with the transport conveyor in accordance with the present invention. The printed material as shown is in a web or roll form having the images, impressions, holograms, land marks, targets, or other markings, collectively referred the hereinafter as “impressions” is passed along a transport conveyor through the inspection station. In the preferred embodiment printed material is preprinted and feed into the inspection station. However, it should be understood that the inspection station could be situated in-line with a printing press that has created the impressions to be inspected. In addition, it is contemplated that the pre-printed media may be in sheet form and supplied to the inspection station directly from the printing press or supplied off-line from a stack of sheets transported on pallets to the conveyor transport.

Once the printed material is placed on the conveyor the movement of the transport is synchronized by a conveyor synchronization device that is controlled by an encoder sensor. As the printed material passes along the transport it is recognized by the trigger sensor that activates the conveyor synchronization device and the color print quality management system. The cameras in the color collection device digitizes and captures the color images of the impressions which are passed on to the print quality management system that performs image reformation, print quality detection, and color density. The results of these measurements are collected, collated to form an overall decision is determined that is relayed to the conveyor synchronization device. As the printed material passes under the results sensor, the conveyor synchronization device signals the transport conveyor controller with the results and status of the impression.

The color image collection device of the present invention generates color digital images from a 3-color digital line scan camera positioned over the printed material on the transport conveyor. The line scan camera requires the use of a rotary encoder also positioned over the printed material on the transport conveyor to ensure that lines of equal height are captured. As illustrated in FIG. 1, the transport conveyor moves the impression below the cameras in the color image detection device, and the impression mark sensor signals the camera (through the conveyor synchronization device) to capture the next impression and store it as a digital color image in the image memory buffer that is shared with the CPUs that accumulate and process the as described hereinafter within the print quality management system.

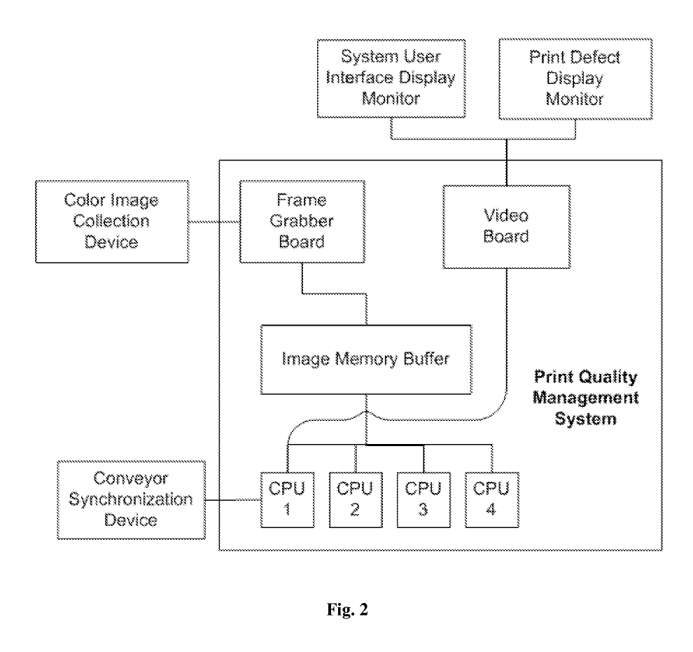

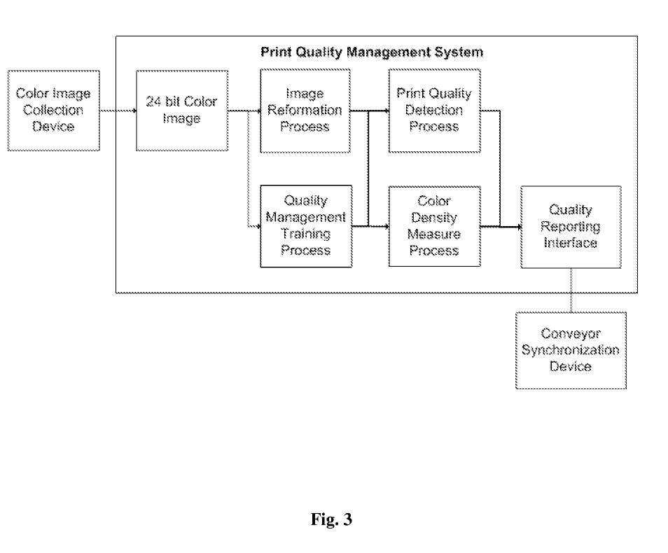

Turning now to FIGS. 2 and 3 which illustrate the elements and processing of the print quality management system. When the image has been fully captured, the system then begins the inspection process. As shown in FIGS. 2 and 3 the inspection process utilizes a real-time computing environment receiving inputs from the color image collection device and conveyor synchronization device. These inputs are processed by a frame grabber board, image memory buffers, video board, and with a plurality of computer processor units (“CPUs”) in order to produce the inspection results in a timely manner. To achieve this, the inspection system automatically distributes segments of the image, corresponding reference data, and inspection methods to each CPU so that the processing load is balanced. It should be understood that the plurality of CPUs may be replaced in the future with a single CPU which could be programmed and capable of processing the data in real time.

As illustrated in FIG. 3, the first step in the inspection process after the image is received and stored, the image is reformatted by the reformation process. The purpose of this is to align the newly acquired image to a reference image which has faultless collection of impressions (sometimes referred to as a golden stand in the trade. This is done by locating predetermined printed landmarks in the newly captured image and digitally shifting it in order to align the found landmarks of the captured image to the same location of those landmarks in the reference image.

The printed landmarks are found in the image via correlation: the reference landmark kernel is matched to similarly sized areas of the image within a fixed search window, and the location of the best correlation is adjusted for best sub-pixel placement.

uses the found landmarks to digitally manipulate the camera image in order to register its placement with that of the reference image. This transformation will produce an image that is registered to the reference data. The algorithm computes the transformation from the camera image to the reference image coordinates using the following equation:

x′, y′=A₁+B₁x+C₁y, A₂+B₂x+C₂y

Where:

x and y are coordinates in the camera image

x′ and y′ are coordinates in the reference image

A₁, A₂, B₁, B₂, C₁ and C₂ are the coefficient results computed from the found landmarks

Once the impression is imaged and the image reformatted, two separate analyses are performed, one for defects and the other for ink density. In the first (defect) analysis, the image is analyzed for defects using the reference image as the quality standard. In order to do so, the reformatted image is first spatially filtered (blurred) to reduce extraneous high-spatial-frequency components. This is achieved by correlating the image with a 3×3 symmetric non-negative kernel whose coefficients sum to 1.

The resulting filtered image is then converted into an Luminance, Chrominance, Hue image representation (“LCH”). For each pixel in the filtered image, the three color components are combined and used as an address. A look-up table is then evaluated at that address, with the result being the converted LCH value. The LCH values in the look-up table were previously computed using the RGB to XYZ to LAB to LCH method defined by the Commission Internationale de L'Eclairage.(“CIE”).

The inspection system uses the 1994 CIE method for measurement of delta E (ΔE) to measure the difference of the LCH image from the reference image generated by the quality management training process. Each pixel in the LCH image is combined with its corresponding pixel in the reference image to compute an address that is used with another look-up table to produce a delta E image representing the deviation from the reference image.

$$Δ E = \sqrt{{( \frac{Δ L}{{K}_{L} {S}_{L}} )}^{2} + {( \frac{Δ C}{{K}_{C} {S}_{C}} )}^{2} + {( \frac{Δ H}{{K}_{H} {S}_{H}} )}^{2}}$$

For each pixel in the delta E image, the deviation from the reference image is compared to its sensitivity detection threshold. This is accomplished by first subtracting the acceptable local variation (as computed in the print management training process) at each pixel from the corresponding delta E value clipping the result at zero. Based on this result, pixels are categorized as acceptable, minor, moderate and severely flawed. The classification of the differences is determined by specified thresholds that are position dependent and defined by the operator. Any resulting clusters of defects are then analyzed to determine their spatial characteristics and identify their perceptual size. The size is then converted into a quality score where the minimal acceptable quality score is 50 out of a range from 0 to 100 by mapping the size onto an integral curve (monotonic S-shaped curve). If the resulting quality score has a number less than 50, then the impression is rejected.

For the second (ink density) analysis, the system uses the reformatted image to compare the proportional average color response (R_{avg}/Rₘₐₓ, G_{avg}/Gₘₐₓ, B_{avg}/Bₘₐₓ) of the print at specified areas of the image and that of the corresponding areas in the reference image. The proportional average values are converted to optical density (O.D.=-log(value)) that represent the respective densities of the specified areas. Primary cyan (C), magenta (M), and yellow (Y) densities are determined from their color opposites. Visual (V) density is based upon the luminance component of the image. The system compares the measured density against acceptable levels for each area in the reference image data to determine if the impression should be rejected.

Once the defect analysis is complete the quality reporting interface displays the inspected image on the print defect display monitor as shown in FIG. 2. Defective pixels are represented with a color-coding that signifies the severity of the defect. Non-defective pixels are either represented by the actual color intensity captured by the camera or by a gray value scaled to the magnitude of the delta E distance between the pixel and the quality reference. If the impression is rejected, areas containing defects that exceed the reject thresholds are highlighted by a box drawn in the print defect display image. Additional inspection information is presented to the operator on the graphical user interface monitor in the form of a time-plot of the overall quality grade for every impression inspected. When the density analysis is complete, the quality reporting interface displays the results to the operator in two forms on the user interface monitor shown in FIG. 2.The first is a bar graph where each bar represents the density difference between the impression image and the reference image within a vertical segment of the image for each defined color of the last impression inspected. The second is a time-plot that contains the worst measured density difference of each defined color for every impression inspected. Other displays of the data may be made based on the operators requirements.

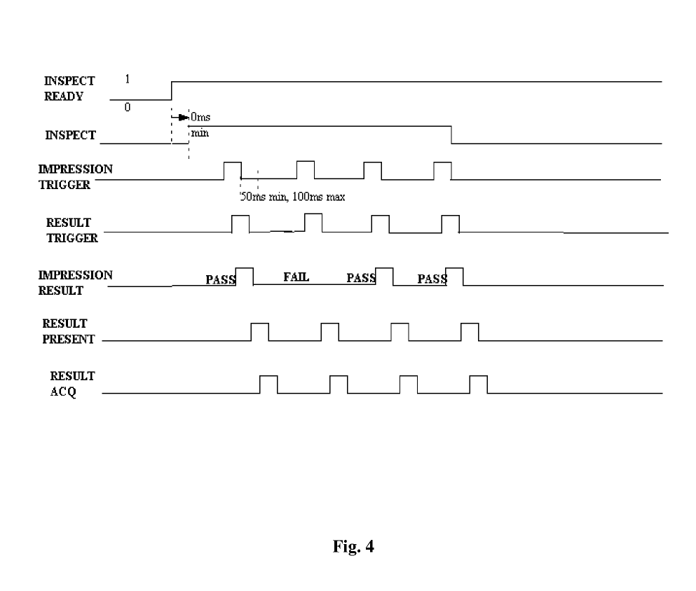

When the impression is fully inspected the conveyor synchronization device is responsible for indicating to the transport the results of the inspection. The quality reporting interface notifies the conveyor synchronization device of the results for each impression when the inspection is completed. After the results sensor is triggered by an impression passing beneath the sensor on the transport conveyor, as shown in FIG. 4, the conveyor synchronization device signals the corresponding impression result to the transport.

Quality management training is an interactive process with an operator and the user interface for generating reference data and assigning inspection thresholds. There is a separate training for the Print Quality and Ink Density processes. Each training process relies on captured images of acceptable impressions. Each captured image is aligned to a fixed reference geometry where absolute positioning is meaningful. Thus training needs to include methods of determining alignment data. The initial step of training is a method of choosing landmarks by the operator.

When it comes to training print quality, the operator defines groups of rectangular regions (called subjects). The operator also defines polygonal areas (called regions) within or spanning subjects. The image content of subjects within a group and between groups may or may not be identical. In the event that the image content is identical, the user is allowed the option of defining regions for one subject or group and then replicating those regions to other subjects or groups. The user is presented with the ability to assign each region with its own set of thresholds. In this way, the user has the ability to tailor the inspection to the material.

Included in the print quality training is the determination of the acceptable variation at every pixel location. This is accomplished by incorporating the same methods used for the inspection as follows. Each captured training image is first aligned to the fixed reference geometry. The aligned image is then blurred and converted to an LCH image. This image is used to generate a local minimum and local maximum image where the minimum and maximum values are determined from the values at every pixel location and some collection of its neighbors. From the resulting images, the minimum and maximum values at every pixel location are determined. These two images are then used to determine the acceptable local variation at every pixel location. The computed variation is half the delta E difference between the minimum image and the maximum image. The reference image is generated by averaging the minimum and maximum images.

When it comes to training ink density, the operator identifies rectangular regions that correspond to regions of uniform inking. These regions may be printed test patterns in the margins of the image, or may be within the printed design. The operator defines the color that each region corresponds to. The system automatically segments the image vertically, determines the primary component to use for measuring density, and calculates a reference density. The operator assigns thresholds that determine how far the measured density is allowed to vary without being rejected.

During the quality management training process, the system defines nominal values for tolerances and sensitivity settings that the operator can adjust later. The sensitivity of the measurements specified in the reference image data can be adjusted to allow operators to customize how the system detects and rejects defects.

One or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. An inspection device for determining if impressions on printed material are defects using a web transport comprising:
an optical imaging device that creates digital images of impressions on printed material;
a transport control device that synchronizes the web with the optical imaging system; and
a processing system receiving inputs from the imaging device and determines if the impressions on the printed material are outside a predetermined quality image range that are to be classified as printing defects.

2. The device as claimed in claim 1, wherein the transport control device includes a rotary recorder that signals when the web has travelled a fixed distance to produce image lines of a constant height.

3. The device as claimed in claim 2, wherein the transport control device includes a mark sensor positioned over the web that triggers a starting position of a newly arrived impression.

4. The device as claimed in claim 1, wherein the optical imaging device includes a camera which digitizes the color images of the impressions.

5. The device as claimed in claim 4 in which the camera is a digital 3-color line-scan camera.

6. The device as claimed in claim 3, wherein the optical imaging device includes an array of white light emitting diodes mounted above the web transport and focused to provide continuous uniform illumination of the printed impression.

7. The device as claimed in claim 4, wherein the digitized inputs are distributed across a plurality of CPUs in the processing system to produce inspection results.

8. The device as claimed in claim 7, wherein the processing system compares the retrieved digitized color image are compared to a reference image using a number of landmarks distributed evenly throughout the printed impressions.

9. The device as claimed in claim 8, wherein the processing system includes means for storing the inspected images with an indication of all defects were found onto a digital storage device.

10. The device as claimed in claim 9, wherein the processing system includes means for displaying inspected image quality results on a digital display device.

11. The device as claimed in claim 8, wherein the processing system has means for providing the results of the defects found to an inspection device operator in a manner that is easily understandable.

12. A method of inspecting printed materials to detect impression defects on a web transport comprising:
providing an optical imaging system creating digital color images of the impression on the printed material;
synchronizing the web transport with the creation of the optical images: and
determining if the impressions on the printed material are outside a predetermined image quality range that are to be classified as defects.

13. The method as claimed in claim 12, which includes comparing the digital color image to a reference image using a number of landmarks distributed evenly throughout the printed impressions.

14. The method as claimed in claim 13, which includes providing continuous uniform illumination of the printed impression by an array of white light emitting diodes mounted above the web transport.

15. The method as claimed in 14, wherein the synchronizing is controlled by a rotary recorder that signals when the web has travelled a fixed distance to produce image lines of a constant height.

16. The method as claimed in claim 15, wherein the synchronizing is also controlled by a mark sensor positioned over the web that triggers a starting position of a newly arrived impression.

17. The method as claimed in claim 16, wherein the optical imaging system includes a camera which digitizes the color images of the impressions.

18. The method as claimed in claim 17 in which the camera is a digital 3-color line-scan camera.

19. The method as claimed in claim 18, wherein the determination of which impressions are to be classified as defects uses the digitized inputs received from the optical imaging unit that are distributed across a plurality of CPUs.

20. The method as claimed in claim 19 includes displaying inspected impressions that are classified as defects on a digital display device.
